(19) United States
(12) Patent Application Publication
(10) Pub. No.: US 2024/0077141 A1
(43) Pub. Date: Mar. 7, 2024

(54) A FLUID CONTROL SYSTEM

(71) Applicant: DROPTECH AS, Kristiansand S (NO)

(72) Inventors: Emil Mühlbradt SVEEN, Kristiansand S (NO); Rolf ANDERSEN, Søgne (NO)

(21) Appl. No.: 18/261,594

(22) PCT Filed: Jan. 14, 2022
(86) PCT No.: PCT/EP2022/050764

§ 371 Date: Jul. 14, 2023

(30) Foreign Application Priority Data
Jan. 15, 2021 (NO) 20210053

(51) Int. Cl. F16K 3/34; F16K 3/26; F16K 27/00

(52) U.S. Cl. CPC F16K 3/34; F16K 3/26; F16K 27/003; F16J 15/50

(57) ABSTRACT

The present invention relates to a fluid control system comprising a first chamber, a second chamber and a passage extending between said upstream chamber and said downstream chamber. An elongate valve spool core (8) is moveable arranged in passage in a fluid-tight and snug-fit manner, the spool core containing a groove (9). An actuator (18) typically connected to the elongated valve spool core to move the valve spool core in relation passage. Thereby a flow rate of a fluid flowing from the upstream chamber to the downstream chamber may be changed by moving the spool core relative to the passage to increase an orifice area.

### FIELD OF THE INVENTION

The present invention relates to a fluid control system comprising a first chamber, a second chamber and a passage extending between said upstream chamber and said downstream chamber. An elongate valve spool core is moveable arranged in passage in a fluid-tight and snug-fit manner, the spool core containing a groove. An actuator typically connected to the elongated valve spool core to move the valve spool core in relation passage. Thereby a flow rate of a fluid flowing from the upstream chamber to the downstream chamber may be changed by moving the spool core relative to the passage to increase an orifice area.

### BACKGROUND OF THE INVENTION

In many fluid related applications, a need exists for administering one or more fluidic substances. Such an administering often involves that the administration is metered so as to provide a predefined mass or volume flow of one or more fluidic substances and such predefined mass or volume must often be administered with a high accuracy.

Further, such high accurate administering often has to be achieved in wide variety of mass or flow rates often spanning one or more decade. This is for example the case when considering administering of one or more chemicals during harvesting of for instance crude oil.

In the oil and gas industry many different types of flow control valves are used, often with a flow control loop, to obtain a safe and effective extraction of fluid, gaseous and solid hydrocarbons. An example of such a control loop is a loop to regulate the amount of a given process chemical that should be injected into the flow mix of hydrocarbons. The set point of such loop is fundamentally given by the chemistry of the hydrocarbon mix, a desired Parts Per Million (PPM) of a certain process chemical that the hydrocarbon mix requires to avoid a defined problem, or to improve a given process to a defined result, and finally the flow rate or volume of the hydrocarbon mix. Such a set point could therefore be very low, e.g. a flow rate of less than 1 litre per hour. At the same time the process pressures could be very high. In addition, other process variables could vary over time, e.g. temperature and viscosity of the fluids, or the fluid pressures upstream or downstream from the control loop.

Such varying and challenging conditions means that the control loop, but especially the control valve, has very high demands put upon it. In such low flow regimes and high differential pressures, traditional types of valves like ball valves, globe valves, butterfly valves, servo valves, proportional valves, and needle valves does not always achieve satisfying results. There are also issues with an inherent high input gain when these types of valves are in an almost closed position. An equal percentage type flow characteristic is thus desired, however the traditional types and versions of equal percentage control valves have not been implemented for use in offshore topside chemical injection for various reasons.

Today, administering of fluidic components are possible by e.g. a traditional needle valve but is has been found that while high accuracy may be achieved in a limited range of administering, the accuracy is often not achieved if the valve is designed to cover a larger range of volume or mass flow ranges.

In the industry a turn down ratio of 10:1 is considered acceptable, i.e. a control valve that can control the process flow in a range of e.g. 10 litre per hour maximum down to a minimum of 1 litre per hour. There are also industry accepted solutions that have a turn down ratio as low as 4:1. For any operator, the effect of these relatively small turn down ratios is reduced process agility. I.e. changes to the flow set point over time may require the substitution of a fully functioning control valve. It also means that one operator within the same process may need several different valve types and valve configurations to achieve the correct flow rates at all the different sub-processes. A control valve with a high turn down ratio that could be used for all sub-processes within the same valve hardware configuration, would therefore be beneficial to the process operator.

Therefore a new type of flow control valve which can achieve very low flow rates with high differential pressure across the valve orifice, yet simple and cost effective, will be beneficial and an improved fluid control system would be advantageous, and in particular a fluid control system efficient and/or reliable would be advantageous.

### OBJECT OF THE INVENTION

An object of the invention is to provide a fluid control system having improved accuracy with respect to metering out a fluid. It is a further object of the present invention to provide an alternative to the prior art.

### SUMMARY OF THE INVENTION

Thus, the above described object and several other objects are intended to be obtained in a first aspect of the invention by providing a fluid control system preferably comprising
a first chamber, a second chamber and a passage extending between said first chamber and said second chamber,
spool shaft adapted to be moveable placed or moveable placed in the passage preferably in a fluid-tight and preferably in a snug-fit manner, the spool shaft containing a groove extending at least partly in longitudinal direction, the cross-section of the groove is increasing from the first chamber to the second chamber,
an actuator connected to the spool shaft and adapted to move the spool shaft in relation to the passage,
wherein
   the length of the groove within the passage defines a fluid passage for fluid flowing from the first chamber to the second chamber with an orifice area defined by the cross-sectional area of the groove at the side of the first chamber at the beginning of the passage,
whereby a flow rate of a fluid flowing from the first chamber to the second chamber is changed by moving the spool shaft relative to the passage to increase the orifice area.

In preferred embodiments, the length of the passage and the length of the groove may be mutually dimensioned such for at least for a part of the extension of the groove within the passage, preferably half the length, an increase in the orifice area provided by moving the spool shaft in the passage, results in a decrease of the fluid passage defined as the length of the extension of the groove within the passage.

In preferred embodiments, the system is contained in a housing, where the first chamber may define an inlet side and the second chamber an outlet side.

In preferred embodiments, the increase of cross-sectional area the groove may be essentially quadratic with respect to the length direction of the groove.

In preferred embodiments, the cross-sectional shape of the groove may be approximately triangular.

In preferred embodiments, the flow leaving the end of the groove may be unrestricted.

In preferred embodiments, the passage, spool shaft and elongated valve spool core may be cylindrical in cross section.

In preferred embodiments, the housing may comprise a through-going opening in the inlet or outlet side of the housing adapted to contain the elongated valve spool core, wherein the elongate valve spool core may extend through the through going opening.

In preferred embodiments, the elongate valve spool core may further comprise a second groove positioned, preferably symmetrically, opposite the groove.

In preferred embodiments, the groove may be positioned at the end of the elongate valve spool core at the second chamber side.

In preferred embodiments, the housing may further comprise a through-going opening at the outlet or inlet side of the housing adapted to contain the elongated valve spool core, and wherein the elongated valve spool core may extend through the openings to compensate for the axial forces.

In preferred embodiments, the elongated valve spool core may further comprise a recessed section at the second chamber side of the elongated valve spool core below the groove.

In preferred embodiments, the fluid system may further comprise a valve lining at the passage, wherein the valve lining and the elongate valve spool core, such as in particular the spool shaft, may be mutually adapted to provide a fluid-tight sealing except for the orifice area.

In preferred embodiments, the housing may comprise a knife to be placed in the path of the groove for cleaning the groove.

In preferred embodiments, the knife may be attached to a spring mechanism for retracting and extending the knife to clean the groove.

In preferred embodiments, the elongate valve spool core may contain a rotational stop to limit galling by the valve rotating In preferred embodiments, the elongate valve spool core, such as the spool shaft, and/or passage may contain an O-ring or other sealing elements(s) at the inlet side over the groove for establishing a zero flow configuration.

By “zero flow configuration” due to the presence of an O-ring or other sealing element(s) is preferably meant a fluid tightness as usably obtained by such sealing, which typically means fluid tight in the sense of negligible fluid flow e.g. essentially zero fluid velocity relative a boundary of the O-ring or sealing element(s).

In preferred embodiments, the elongate valve spool core may comprise two or more grooves in parallel for providing a larger fluid flow rate. These grooves are preferably provided in the spool shaft.

In preferred embodiments, the depth of the groove may increase with 0.03 mm pr. millimetre of movement along the elongate valve spool core, preferably 0.02, more preferably 0.01.

In preferred embodiments, a turn down ratio of the system may be in excess of 1:10.000, with the same differential pressure across the system.

In preferred embodiments, the fluid flow rate defined by the groove may be controllable to less than 100 litres per hour, more preferably less than 1 litre per hour.

In preferred embodiments, the elongate valve spool core may comprise a spool shaft adapted to fit in a snug-fit manner within the passage and an internal shaft extending through the valve housing on only the inlet side or both the inlet and outlet side.

In preferred embodiments, the length of the groove may be at least as long as the passage.

In a second aspect, the invention relates to method for operating the fluid system according to the first aspect. Such a method may comprise moving the elongate valve spool core to control the flow of fluid by changing the orifice area.

Words used herein are used in a manner being ordinary to a skilled person. However, some the used terms are elaborated in the following:

“Fluid-tight and snug-fit” is preferably used to reference an interaction between two or more components along a common interface such as defined by surfaces of the two or more components abutting each other, wherein the two or more components can be moved relatively to each other while still essentially preventing fluid from passing through the common interface. “Essentially preventing” typically refers to that a leakage of fluid can be ignored compared to the amount of fluid passing through a fluid control system according to the invention, and “ignored” typically refers to that the amount of fluid leak is less than 0.5%, preferably less than 0.1% such as less than 0.05% or even less that 0.01% of the fluid passing through the fluid control system. In some preferred embodiments, the fluid passing through the fluid control system may be a maximum rated fluid passing through the fluid control system. In some preferred embodiments, the fluid leak is between 0.025% and 0.00125% of the fluid passing through the fluid control system. Fluid-tight and snug-fit may in certain embodiments be obtained by polishing the surfaces abutting each other.

As presented herein, the groove(s) provided in the spool shaft may in some embodiment extend only partly in the longitudinal direction of the spool shaft leaving a section above (see e.g. FIG. 3, numeral 16a) or below groove with no groove. In such embodiments, the fluid control system may be closed for fluid flow by positioning the spool shaft relatively to the passage so that no orifice area is present, e.g. positioning the section 16a of FIG. 3 so that it extends in the passage 4. Fluid-tight and snug-fit preferably applies to this closed position.

Further, fluid-tight and snug-fit preferably also applies to the situation where the spool shaft is positioned relatively to the passage so the fluid flows via the orifice area through groove, and here the fluid-tightness refers to the tightness between the area of the spool shaft not occupied by the groove and the opposite area of the passage.

It is noted that “fluid tight” may depend on a particular use in a particular industry, such that a test can be performed to measure any leakage. Such a test may include a given specification of fluid characteristic and type, fluid temperature, equipment temperature, fluid pressures, measurement characteristics and even other specifications.

### BRIEF DESCRIPTION OF THE FIGURES

Preferred embodiments of the fluid control systems according to the invention will now be described in more detail with regard to the accompanying figures. The figures show ways of implementing the present invention and are not to be construed as being limiting to other possible embodiments falling within the scope of the attached claim set.

FIG. 1 is a schematically illustration of a fluid control system according to an embodiment of the invention; the fluid control system is illustrated in a cross sectional view taken along a longitudinal direction of the fluid control system;

FIG. 2 shows an cross sectional view of the embodiment of FIG. 1 along line “CS”;

FIG. 3 shows in a 3-dimensional view an embodiment of the spool core and spool shaft (only a section of the spool shaft is shown);

FIG. 4 shows in a 3-dimensional view an embodiment of a fluid system in a housing; in the figure; various components are made partly transparent to reveal interior components and structures;

FIG. 5 shows in a 3-dimensional view an embodiment of a fluid system with a pressure-compensating groove;

FIG. 6 shows in a 3-dimensional view an embodiment of the fluid system; various components are made partly transparent to reveal interior components and structures

FIG. 7 shows a spool core and valve lining according to a preferred embodiment (the chambers and housing are not illustrated);

FIG. 8 shows flow characteristics obtainable by a preferred embodiment of the fluid system;

FIG. 9 shows in a 3-dimensional view a preferred embodiment of the fluid system comprising a cleaning knife; various components are made partly transparent to reveal interior components and structures; and

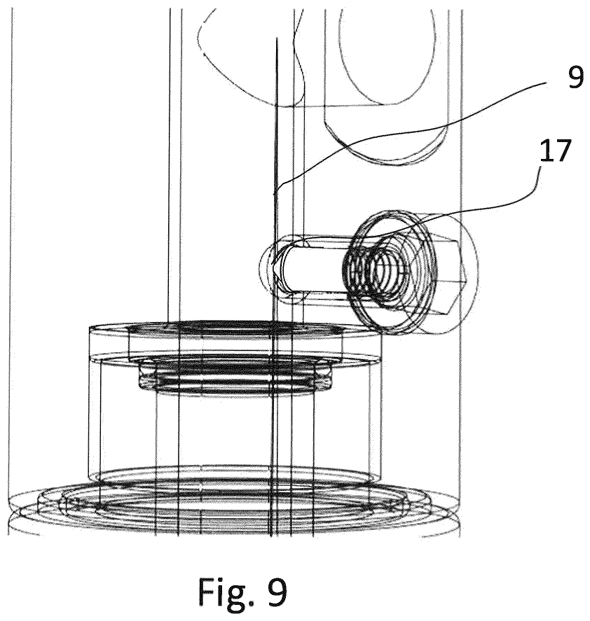

FIG. 10 shows the cleaning knife of FIG. 9 in a retracted and activated position.

### DETAILED DESCRIPTION OF PREFERRED EMBODIMENTS

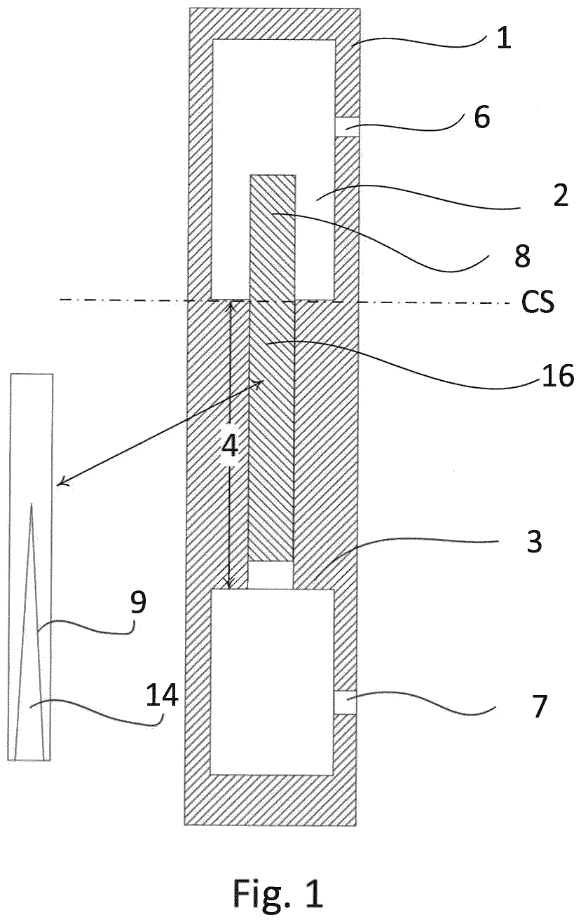

An embodiment of a fluid control system according to the present invention is shown in FIG. 1. As shown in FIG. 1 the fluid control system comprises a first chamber 2, a second chamber 3 and a passage 4 extending between the upstream chamber 2 and the downstream chamber 3. An elongated valve spool core 8 is moveable arranged within the passage 4 in a fluid tight and snug-fit manner, such that essentially no fluid can flow through the passage except from flowing through the groove 9. The groove 9 is machined into the spool core 8 in such a way that when the elongate valve spool core is arranged passage 4, the groove 9 will have a directional component extending in the direction defined by the extension of the passage 4.

In FIG. 1, the groove 9 is illustrated as having a triangular projected shape. By projected is meant the edges defined between the groove and the elongate valve spool core 8 projected onto a plane defines a triangle. However, the groove 9 may be given other shapes than the one disclosed. Kindly observe, that FIG. 1 is a longitudinal cross sectional view and the spool core 8 is shown in a non-cross sectional view to the left in FIG. 1.

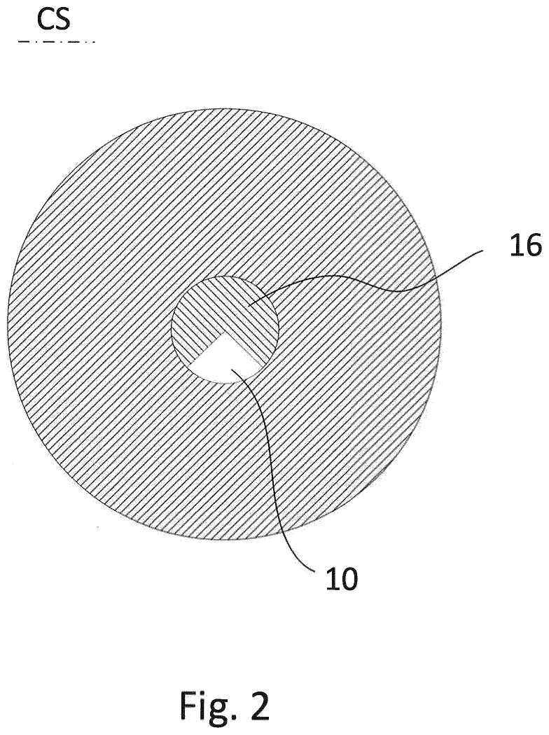

As perhaps most visible in FIG. 2, the groove 9 may have a cross section resembling a pie-shape when spool core 8 is located in the passage 4, where the outer perimeter of the groove is formed by the inside of the passage 4. The angle of the pie-shaped angle is preferably 90 degrees, but the invention is not limited to such 90 degrees. Preferably, the angle may be between 100 and 80 degrees.

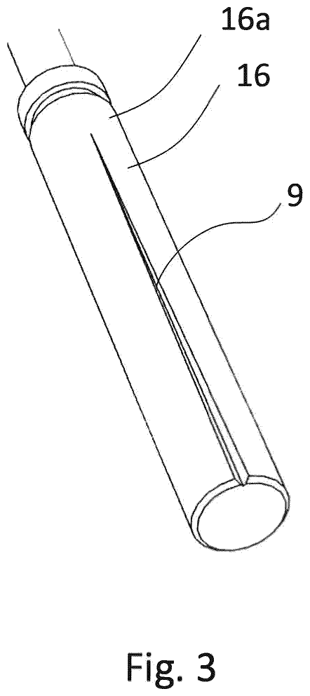

The part of the elongate valve spool core 8 which is designed for being moved within the passage 4 is herein referred as the spool shaft 16. The shaft 16 part can be seen in FIG. 3.

The groove 9 is extending in depth, such that the cross-section (considered perpendicular to the length direction of the elongate valve spool core 8) of the groove 9 is increasing in a direction from the upstream chamber 2 to the downstream chamber 3. The length of the groove 9 within the passage 4 will define a fluid passage 14 from the first chamber to the second chamber.

In some embodiments, the length of the groove 9 will at least be the length of the passage 4, ensuring that the groove will define a fluid passage 14 for fluid going from the upstream chamber to the downstream chamber, however, this is not essential. In embodiments, where the groove is not at least the length of the passage 4, either the groove will extend to the end of the spool core or a recessed section is present below the groove. This means that the length of the fluid passage 14 defined by the groove can be controlled.

As perhaps most clearly seen in FIG. 3, a non-grooved section 16a may be provided above the above groove. This non-grooved section 16a may be used to shut-off fluid transport from the first chamber to the second chamber by arranging the elongated valve spool core 8 relatively to the passage 4 so that at least a part of the non-grooved section extend into the passage 4.

The fluid passage 14 will have an orifice area 10 as illustrated in FIG. 2. The orifice area 10 is typically defined as the cross-sectional area of the groove 9 at the upper end of the passage at the side of the first chamber, which in an embodiment is the inlet side.

It is worth mentioning that the orifice area 10 is variable as the elongate valve spool core 8 can be moved at least longitudinally, thereby changing the orifice area 10. However, since the groove 9 becomes larger in a direction towards its end, the orifice area 10 as defined in this manner will be the smallest area a fluid can entry or exit the flow passage 14. See FIG. 2 for a cross-sectional view CS of the fluid control system at the beginning of the passage 4 at the side of the first chamber 2.

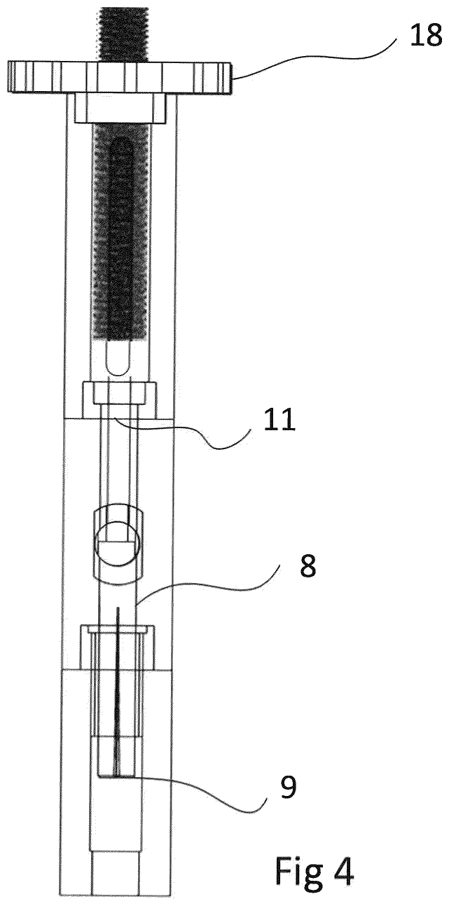

An actuator 18, as seen in FIG. 4, is connected to the elongated valve spool core and adapted to move the elongate valve spool core 8 in relation to the passage 4, such that by moving the elongate valve spool core 8 relative to the passage 4, the orifice area 10 of the groove can be changed. This result in a decreasing area gain for any axial input to the spool core with decreasing orifice area, or said in another manner, if the elongate valve spool 8 is moved upward (orientation given as in FIG. 1) the orifice area 10 increases whereas as downward movement results in a decrease in orifice area 10. The groove's area gain should preferable be non-linear. In the embodiment shown in FIG. 4, the actuator comprising an external thread provided on the elongate valve spool core and a turning knob having an internal thread cooperating with the thread of the elongate valve spool core, so that rotation of the turning knob provides a translatory movement of the elongate valve spool core.

The fluid system can therefore obtain a very small flow coefficient by combining a method of controlling the size of a very small area with a low input gain, here the elongate valve spool core, and further decreasing the flow coefficient by including a long and narrow fluid passage 14 to further restrict the flow through the valve after the fluid has passed the valve orifice. This long and narrow fluid passage could be achieved by having a length of the groove of between 20 and 60 mm, such as between 20 and 40 mm. The increase of the depth of the groove 9 in preferred embodiments may be less than 0.05, such as less than 0.04 preferably less 0.03, such as less than 0.02, preferably less than 0.01 mm pr. mm in the length direction of the groove 9. Preferably, the increase is larger than 0.005 mm pr. mm in the length direction.

The fluid control principle may therefore be based on a variable orifice, where two valve chambers of different pressure, the first chamber 2 having a higher pressure than the second chamber 3, are separated by an orifice area that can be manipulated. In addition to the variable area 10, preferred embodiments of the present invention also have a narrow fluid passage length, defined by the length of the groove within the passage 4, which can also be manipulated in length, i.e. by increasing the valve orifice area 10 by moving the elongate valve spool core 8 in longitudinal direction.

Such a configuration allows for the control of the fluid rate by moving the elongate valve spool core 8 in relation to the passage 4. This will increase or decrease the orifice area, depending on the direction of movement, and allow a larger or smaller flow rate to flow through the groove 9. This is due to the flow being in essence restricted by the smallest opening, the orifice area 10, and since the flow is from the upstream chamber to the downstream chamber, which is the same direction the groove is expanding, the limiting feature is the orifice area. It is noted that flow resistance will of course be present when the fluid is flowing through the groove, however it has been found that such flow resistance plays a secondary role compared to the size of the orifice area 10. As seen in FIGS. 1 and 2 in combination, the passage 4 and elongate valve spool core are cylindrical in shape, but other shapes are envisioned

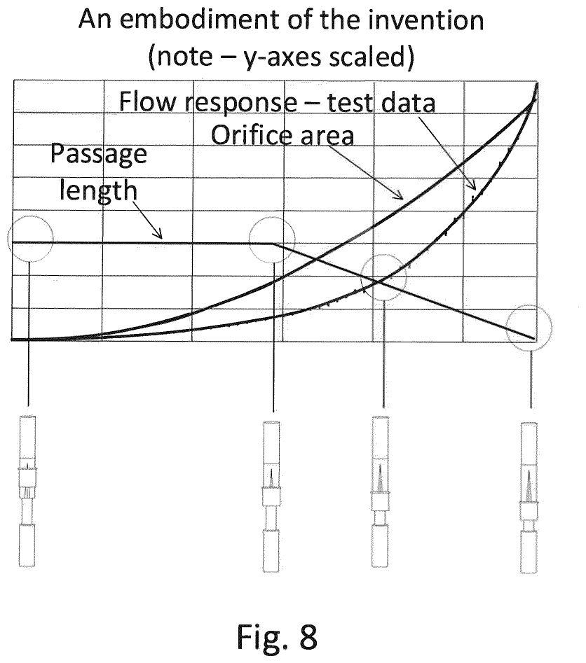

This essentially means that the flow is controlled by two parameters, the increase of the groove and the length of the groove, in essence the length of the fluid passage 14. As seen in FIG. 8, an embodiment of the fluid characteristic of the invention is shown. In FIG. 8 is shown the flow response, the orifice area and the passage length dependent of the movement of the valve spool within the spool core. Positive movement correlated to moving the valve core upwards from a zero movement configuration where the orifice area is zero to a maximum movement configuration, where the groove is just in contact with the passage 4.

The groove forming basis for the data in FIG. 8 is longer that the passage 4, such that as seen in FIG. 8 for at section of the movement no change in passage length is seen and only small changes in the flow response is seen. This is due to the increase in flow is only due to the increase orifice area, thereby the opening allowing fluid to flow.

When the core is further moved a point where the end of the groove will move into the passage 4 is achieved. As the flow below this point is allowed to flow unrestricted, the length of the fluid passage will decrease, as illustrated in FIG. 8. This decreased length of the fluid passage will allow for a larger flow, since the length of the flow passage restricting flow is decreased. The combined effect of the orifice increase and the decrease in passage length thereby allows for an almost exponential flow-response curve, as seen in FIG. 8. The different configuration can be seen in the circles shown in the graph.

In some embodiments, the elongated valve spool core 8 and the actuator 18 are formed integral with each other.

In the present invention, the contact surfaces between the passage 4 and the elongate valve spool core 8 are smooth, or at least the surface of the spool shaft 16 to be moved within the passage, with a low surface roughness. In terms of roughness, the surfaces contacting each other are typically machined to have a surface roughness <0.8 Ra. This will allow for a tighter snug fit between the passage 4 and the spool shaft 16, of the elongate valve spool core 8. The smooth surface also allows for easy movement of the elongate valve spool core 8 within the passage 4, due to the low friction coefficient. Besides the surface roughness, it may also be relevant to consider a magnitude of a clearance between the surface of the passage 4 and the surface of the elongate valve spool core or spool shaft to be moved within the passage. Typical, non-limiting examples on suitable clearances are less than 16 microns, such as less than 15 microns, preferably less than 14 microns, such as less than 13 microns, preferably less than 12 microns, such as less than 11 microns, preferably less than 10 microns, such as less than 9 microns, preferably less than 8 microns, such as less than 7 microns, preferably less than 6 microns, such as less than 5 microns, preferably less than 4 microns, and preferably larger than 1 microns, preferably larger than 2 microns, such larger than 3 microns. While the material(s) used for the fluid control system typically is (are) of a kind having a negligible thermal expansion, the clearance is typically evaluated at 20 degrees Celsius. Micron refers to 10⁻⁶ metre.

In some embodiments, the fluid system is contained in a housing 1, where the first chamber 2 defines an inlet side, and the second chamber 3 an outlet side. Such a housing 1 could be part of a pressure compensating system.

As seen in FIG. 1, the groove 9 could in some embodiment be approximately triangular. It is preferred that the increase of the cross-sectional area of the groove is such that the flow response is essentially exponential and a quadratic growing shape could achieve this with the combination of a long and narrow variable length fluid passage. In FIG. 8, a graph length of the fluid passage 14, the flow-response and the orifice area are shown. As shown in FIG. 8 the flow-response of the valve is exponential.

Having an exponential response is particular advantageous since it also for precise control of the fluid response at low flow, while also having a high turn down ratio, allowing for control over a large range.

In some embodiments, as the one shown in FIG. 4, the housing 1 or fluid system comprises a through-going openings 11 at the inlet side of the housing adapted to contain the elongated valve spool core 8, wherein the elongated valve spool core 8 extends through the opening 11. As shown, the elongate valve spool core 8 typically extends outside the housing. By this, an actuator, for longitudinal movement of the elongate valve spool core 8, can easily be connected to the section extending outside the housing. Such an embodiment allows for part of the end of the elongate valve spool core 8 to be dry (not in contact with the fluid going through the groove 9) at the inlet side and the other part of the end of spool core to be in contact with the fluid.

In one embodiment of the invention, the external dimensions of the fluid control system should preferably be limited. This may be provided by the elongate valve spool core 8 is thus not allowed to extend through any side of the valve housing 1. In such embodiments, spool shaft 16 actuation and position control is provided by mechanical, by either magnetic, hydraulic or similar measures. The axial force on the spool shaft 16 due to fluid pressure is balanced by known methods similar to those used in e.g. servo valves.

In some preferred embodiments, the groove 9 is positioned so that it terminates and has its widest cross section at an end of the elongate valve spool core 8. As seen in FIG. 4, the end in question is the one extending into the second chamber 3.

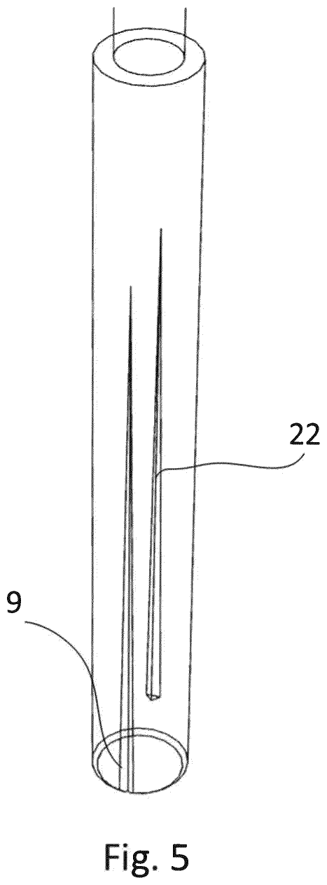

In order to compensate for the radial forces of the system a second groove 22 can be manufactured into the spool shaft, as seen in FIG. 5. Such a second groove 22 will compensate for the pressure and forces experienced by the groove, such as the radial forces experience by the valve. The pseudo-groove will be manufactured opposite to the groove 9 and as seen will preferably not terminate at the end of the spool core or a recessed section of the spool core, such that it will not define a flow passage.

This could be advantageous where the fluid pressures are very high, e.g. in excess of 350 bar, such that a symmetrical spool shaft 16 to balance radial forces between the spool shaft 16 and the passage 4, due to the static pressure of the fluid. The orifice shaft 16 could in this case have two or four grooves 9 separated by 180° or 90°, thus each pair of orifice passages 4 would radially balance the forces from the other.

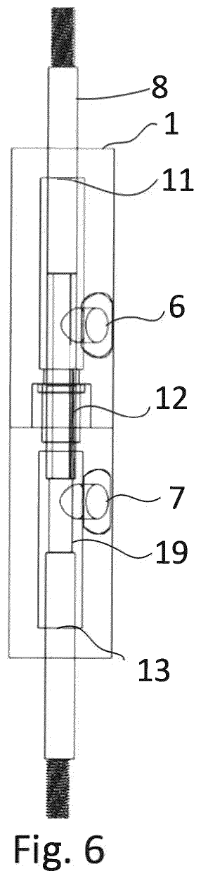

Referring to FIG. 6, a different embodiment of the fluid control system is illustrated. In this embodiment, the housing 1 further comprises a through-going opening 13 at the second chamber 3 (outlet side) of the housing adapted to receive a section of the elongated valve spool core 8 in a fluid-tight manner by use of packing to seal the passage. The packing may be provided by an elastomer providing essentially zero-flow configuration, typically up-till a design limit for a pressure difference across the packing. Alternatively, the housing and the elongated valve spool core 8 are configured in fluid-tight and snug-fit manner as otherwise disclosed herein. In such an embodiment, the elongated valve spool core 8 will extend through the housing on both the inlet and outlet side. Such a configuration will balance the axial forces experience by the fluid system due to the groove, both the projected and normal to the axial direction. This will mean that axial forces due to fluid pressure are equal, or close to equal, in the axial direction.

Also seen in FIG. 6, the spool core may contain a recessed section 19 at the outlet side of the elongated valve spool core below the groove 9. This will ensure that the flow is unrestricted to the outlet of the housing and that the length of the fluid passage 14 can be controlled. Further, as the recessed section 19 has a surface on both side of the recess being perpendicular, or at least having a projected area being perpendicular, to the longitudinal direction of elongate valve spool core 8, the pressure in the recess acting in opposite direction on these surfaces may essentially outbalance each other.

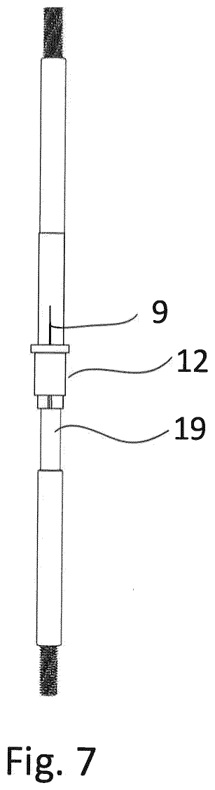

Referring to FIG. 7, an embodiment of the elongate valve spool core 8 and a valve lining 12 is shown. The valve lining 12 and the elongate valve spool core 8 is mutually adapted to provide a fluid-tight sealing except for the orifice area 10. The valve lining 12 is arranged in the fluid control system so as to provide the surface of the passage 4 which contacts the elongate valve spool core 8 in the fluid-tight and snug-fit manner. In this manner the housing can be manufactured with courser geometrical tolerances and coarser surface roughnesses, than required by the lining 12, which makes production of the fluid control system easier. When the elongate valve spool core 8 is to extend outside e.g. the housing, packing is or may be used to provide a sealing, such as in the through-going openings.

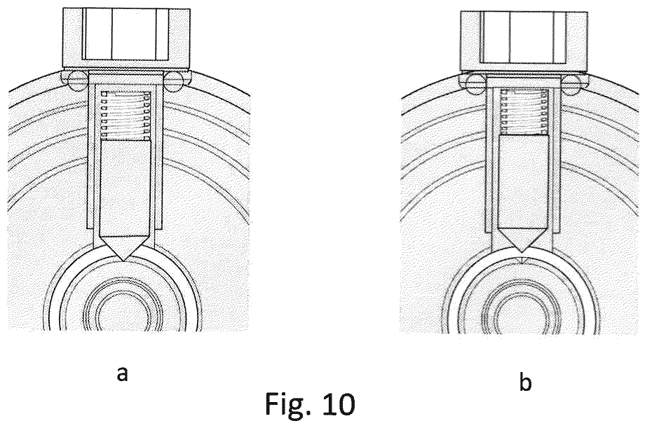

In some embodiments, the fluid system may further comprise a knife 17 to be placed in the path of the groove 9 for cleaning the groove 9. The term knife is not to be construed as strictly limited to knife-shaped object, as it is used to reference inter alia a pointed object adapted to scrape-off debris or other unwanted materials in the groove 9. Such a knife can be seen in FIG. 10. The knife may be placed at the inlet side of the housing, as seen in FIG. 10. The knife 12 will ensure that a controllable amount of fluid will flow through the groove. In FIG. a and b, the knife is shown in an embodiment where a spring mechanism for retracting and extending the knife is present, such that cleaning of the groove can be controlled. In FIG. 10b, the knife is retracted and in FIG. 10a the knife is activated.

The adhesive forces that can form between the spool shaft 16 and the passage 4 for some choice of materials can produce galling stresses that may significantly damage these parts. To avoid reaching a threshold value of galling stress between the parts, the relative acceleration or movement in general between the spool shaft 16 and the passage 4 should be minimised. One way to minimise this is to move the spool shaft 16 in a lateral movement only, and not allow it to rotate around its length axis. A rotational lock to the spool shaft 16 could therefore be incorporated if materials prone to galling stresses were used for the spool shaft 16 and/or the passage 4. Another way of avoiding galling may be to use of non-galling materials. Non-limiting examples on such non-galling materials are Tungsten Carbide (also known as WC, Wolfram Carbide) compound(s) and Tungsten Carbide Nickel compound(s).

To allow for only lateral movement, the fluid system may also contain a rotational stop to limit galling by the valve rotating and further may contain an O-ring or other sealing elements at the inlet side over the groove for further ensuring a zero flow configuration in the elongate valve spool core 8 or passage 4. The O-ring or other sealing elements will ensure that a zero-flow configuration can be established.

In some embodiments, the elongate valve spool core 8 can comprise two or more grooves 9 in parallel for providing a larger fluid rate. In such an embodiment, the total orifice area can be increased without reducing the effect of the long and narrow fluid passage. Such two or more grooves 9 may be substantially identical to each other or may differ from each other. Further, the positioning of the two or more grooves 9 may be staggered both in circumferential direction but also in longitudinal direction.

One embodiment of the invention has an orifice area increase of two or more orifice areas 10, and long and narrow fluid passages 4, that are not equal in length. One can thus obtain the low input gain of a single orifice area/fluid passage at the lowest flow rates, and then increase the gain significantly when the valve configuration is in a more open position where two or more orifice areas/passages 10, 14 allow for passage of fluids.

The depth of the groove is in some embodiments increasing between 0.005 and 0.05, such as between 0.01 and 0.03, such as between 0.01 and 0.015 such as between 0.01 and 0.04 mm pr. millimetre of movement along the spool core, and in other embodiments, the turn down ratio of the system is in excess of 10.000, with the same differential pressure across the system. This creates a long and narrow fluid passage 14 downstream of the orifice area 10. The effect of the long and narrow fluid passage 14 is prominent when the length of the elongate valve spool core 8 is equal to or longer than the passage 4 (downstream of the valve orifice), and reduces the effect the more the spool core is moved towards the upstream chamber 2. When the valve is in its fully open configuration, where the orifice area is the largest while the grove is still extending through the passage 4, the effect of the long and narrow passage is negligible.

The valve can be configured to always reduce the length of the narrow fluid passage 14 with increasing orifice area 10, or have a constant length of the fluid passage 14 in parts of the spool core extension in the spool shaft, and reducing/increasing passage 4 length in others extension intervals. The effect of the narrow passage 4 is most important at lower rates. A typical version of the invention may have a passage 4 with a length of 20-40 millimetres and a spool shaft 16 length of 30-80 millimetres, but other lengths and dimension are possible. For example, if the passage 4 is 40 mm long, and the groove 9 is 80 mm long, the passage 4 has a maximum length of up to 40 millimetres when the groove is fully within the passage 4. Extracting the spool shaft, as shown in FIG. 8 so that the groove 9 is not fully within the passage will decrease the fluid passage length up to maximum orifice area, see FIG. 8. Kindly observe that the y-axis is scaled to allow the plot of the different parameters to fit into a single graph.

As detailed herein, the elongate valve spool core 8 can comprise a spool shaft adapted to in a snug fit manner fit within the passage 4 and an internal shaft extending through the valve housing on only the inlet side or both the inlet and outlet side depending on whether the housing contain one or two through-opening. The core shown in FIG. 6 is adapted to go through both an inlet and outlet through-going opening. The recces section 19 is preferable machined in the internal shaft 21.

A method to operate the fluid system will then comprise
moving the valve spool core 8 to control the flow of fluid by changing the orifice area.

The method could also be accomplished by turning the actuator to get step-wise flow.

This means that by using the fluid system of the current invention and moving the elongate valve spool core 8 in relation to the passage 4, the flow response can be controlled. The length of the groove and the maximum length of the passage can be manufactured to the specifications of the application. The combination of the groove and long and narrow passage allows for a more precise flow regulations.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### Itemized List of Preferred Embodiments

1. A fluid control system (20) comprising
a first chamber (2), a second chamber (3) and a passage (4) extending between said first chamber (2) and said second chamber (3),
spool shaft (16) adapted to be moveable placed in the passage (4) in a fluid-tight and snug-fit manner, the spool shaft (16) containing a groove (9) extending at least partly in longitudinal direction, the cross-section of the groove (9) is increasing from the first chamber (2) to the second chamber (3),
an actuator (18) connected to the spool shaft (16) and adapted to move the spool shaft (16) in relation to the passage (4),
wherein
   the length of the groove (9) within the passage (4) defines a fluid passage (14) for fluid flowing from the first chamber to the second chamber with an orifice area (10) defined by the cross-sectional area of the groove at the side of the first chamber at the beginning of the passage (4),
whereby a flow rate of a fluid flowing from the first chamber (2) to the second chamber (3) is changed by moving the spool shaft relative to the passage (4) to increase the orifice area (10) and
   the length of the passage (4) and the length of the groove (9) are mutually dimensioned such for at least for a part of the extension of the groove (9) within the passage (4), preferably half the length, an increase in the orifice area provided by moving the spool shaft (16) in the passage (4), results in a decrease of the fluid passage (14) defined as the length of the extension of the groove (9) within the passage (4).

2. A fluid control system according to item 1, wherein the length of the passage and the length of the groove are be mutually dimensioned such for at least for a part of the extension of the groove within the passage, preferably half the length, an increase in the orifice area provided by moving the spool shaft in the passage, results in a decrease of the fluid passage defined as the length of the extension of the groove within the passage.

3. A fluid control system according to item 1 or 2, wherein the system is contained in a housing, where the first chamber defines an inlet side and the second chamber an outlet side.

4. A fluid system according to any of the preceding items, wherein the increase of cross-sectional area the groove (9) is essentially quadratic with respect to the length direction of the groove.

5. A fluid system according any of the preceding items, wherein cross-sectional shape of the groove (9) is approximately triangular.

6. A fluid control system according to any of the preceding items, wherein the flow leaving the end of the groove is unrestricted.

7. A fluid system according to any of the preceding items, wherein the passage (4), spool shaft (16) and elongated valve spool core (8) is cylindrical in cross section.

8. A fluid system according to any of the preceding items, wherein the system is contained in a housing, wherein the housing (1) comprises a through-going opening (11) in the inlet or outlet side of the housing adapted to contain the elongated valve spool core (8), wherein the elongate valve spool core (8) extends through the through going opening (11).

9. A fluid system according to any of the preceding items, wherein the elongate valve spool core (8) further comprises a second groove (22) positioned, preferably symmetrically, opposite the groove (9).

10. A fluid system according to item 9, wherein the groove (9) is positioned at the end of the elongate valve spool core at the second chamber side.

11. A fluid system according to any of preceding items, wherein the system is contained in a housing and the housing (1) further comprises a through-going opening (13) at the outlet or inlet side of the housing adapted to contain the elongated valve spool core (8), and wherein the elongated valve spool core (8) extends through the openings (11) to compensate for the axial forces.

12. A fluid system according to any of items, wherein the elongated valve spool core (8) further comprises a recessed section (19) at the second chamber side of the elongated valve spool core below the groove (9).

13. A fluid system according to any of the preceding items, wherein the fluid system further comprises a valve lining (12) at the passage (4), wherein the valve lining (12) and the valve spool core (8) are mutually adapted to provide a fluid-tight sealing except for the orifice area (10).

14. A fluid system according to any of the preceding items, wherein the housing comprises a knife (17) to be placed in the path of the groove (9) for cleaning the groove.

15. A fluid control system according to item 14, wherein the knife is attached to a spring mechanism for retracting and extending the knife to clean the groove.

16. A fluid control system according to any of the preceding items, wherein an elongate valve spool core comprising the spool shaft (16) contains a rotational stop to limit galling by the valve rotating.

17. A fluid control system according to any of the preceding items, wherein an elongate valve spool core comprising the spool shaft (16) and/or passage contains an O-ring at the inlet side over the groove for establishing a zero flow configuration.

18. A fluid system according to any of the preceding items, wherein the elongate valve spool core (8) comprises two or more grooves (9) in parallel for providing a larger fluid flow rate.

19. A fluid system according to any of the preceding items, wherein the depth of the groove is increasing with 0.03 mm pr. millimetre of movement along the elongate valve spool core, preferably 0.02, more preferably 0.01.

20. A fluid control system according to any of the preceding items, wherein a turn down ratio of the system is in excess of 1:10.000, with the same differential pressure across the system.

21. A fluid control system according to any of the preceding items, wherein the fluid flow rate defined by the groove is controllable to less than 100 litres per hour, more preferably less than 1 litre per hour.

22. A fluid system according to any of the preceding items, wherein the elongate valve spool core (8) comprises a spool shaft adapted to fit in a snug-fit manner within the passage (4) and an internal shaft extending through the valve housing on only the inlet side or both the inlet and outlet side.

23. A fluid control system according to any of the preceding items, wherein the length of the groove is at least as long as the passage.

24. A method for operating the fluid system of any of items 1-23, the method comprising
moving the elongate valve spool core (8) to control the flow of fluid by changing the orifice area.

### LIST OF REFERENCE SYMBOLS USED

1. housing
2. first chamber
3. second chamber
4. passage
6. inlet
7. outlet
8. elongate valve spool core
9. groove
10. orifice area
11. through-going openings
12. valve lining
13 second through-going opening
14 fluid passage
15 opening
16 spool shaft
16a non-grooved section of spool shaft
17 knife
18 actuator
19 recessed section
20 fluid system
21 spring mechanism
22 Second groove

1. A fluid control system-WO-comprising
a first chamber, a second chamber and a passage extending between said first chamber and said second chamber,
a spool shaft adapted to be moveable placed in the passage in a fluid-tight and snug-fit manner between the spool shaft and the passage, the spool shaft containing a groove extending partly in longitudinal direction, the cross-section of the groove is increasing from the first chamber to the second chamber,
an actuator connected to the spool shaft and adapted to move the spool shaft in relation to the passage,
wherein
the length of the groove within the passage defines a fluid passage for fluid flowing from the first chamber to the second chamber with an orifice area defined by the cross-sectional area of the groove at the side of the first chamber at the beginning of the passage,
whereby a flow rate of a fluid flowing from the first chamber to the second chamber is changed by moving the spool shaft relative to the passage to increase the orifice area and
the length of the passage and the length of the groove are mutually dimensioned such for at least for a part of the extension of the groove-ECO-within the passage, an increase in the orifice area provided by moving the spool shaft in the passage, results in a decrease of the fluid passage defined as the length of the extension of the groove within the passage.

2. A fluid control system according to claim 1, wherein the length of the passage and the length of the groove are be mutually dimensioned such for at least for a part of the extension of the groove within the passage, an increase in the orifice area provided by moving the spool shaft in the passage, results in a decrease of the fluid passage defined as the length of the extension of the groove within the passage.

3. A fluid control system according to claim 1, wherein the system is contained in a housing, where the first chamber defines an inlet side and the second chamber an outlet side.

4. A fluid control system according to claim 1, wherein the increase of cross-sectional area the groove is essentially quadratic with respect to the length direction of the groove.

5. A fluid control system according claim 1, wherein cross-sectional shape of the groove is approximately triangular.

6. A fluid control system according to claim 1, wherein the flow leaving the end of the groove is unrestricted.

7. A fluid control system according to claim 1, wherein the passage, spool shaft and an elongated valve spool core comprising the spool shaft are cylindrical in cross section.

8. A fluid control system according to claim 1, wherein the system is contained in a housing, wherein the housing comprises a through-going opening in the inlet or outlet side of the housing adapted to contain an elongated valve spool core comprising the spool shaft, wherein the elongate valve spool core extends through the through going opening.

9. A fluid control system according to claim 1, wherein an elongate valve spool core comprising the spool shaft-further comprises a second groove positioned opposite the groove.

10. A fluid control system according to claim 9, wherein the groove is positioned at the end of an elongate valve spool core comprising the spool shaft at the second chamber side.

11. A fluid control system according to claim 1, wherein the system is contained in a housing and the housing further comprises a through-going opening at the outlet or inlet side of the housing adapted to contain an elongated valve spool core comprising the spool shaft, and wherein the elongated valve spool core extends through the openings to compensate for the axial forces.

12. A fluid control system claim 1, wherein an elongated valve spool core comprising the spool shaft further comprises a recessed section at the second chamber side of the elongated valve spool core below the groove-M.

13. A fluid control system according to claim 1, wherein the fluid system further comprises a valve lining at the passage, wherein the valve lining and an elongate valve spool core comprising the spool shaft are mutually adapted to provide a fluid-tight sealing except for the orifice area.

14. A fluid control system according to claim 1, wherein the housing comprises a knife to be placed in the path of the groove for cleaning the groove.

15. A fluid control system according to claim 14, wherein the knife is attached to a spring mechanism for retracting and extending the knife to clean the groove.

16. A fluid control system according to claim 1, wherein an elongate valve spool core comprising the spool shaft contains a rotational stop to limit galling by the valve rotating.

17. A fluid control system according to claim 1, wherein an elongate valve spool core comprising the spool shaft and/or passage contains an O-ring at the inlet side over the groove for establishing a zero flow configuration.

18. A fluid control system according to claim 1, wherein an elongate valve spool core comprising the spool shaft comprises two or more grooves in parallel for providing a larger fluid flow rate.

19. A fluid control system according to claim 1, wherein the depth of the groove is increasing between 0.005 and 0.05 mm pr. millimetre of movement along an elongate valve spool core comprising the spool shafts.

20. A fluid control system according to claim 1, wherein a turn down ratio of the system is in excess of 1:10.000, with the same differential pressure across the system.

21. A fluid control system according to claim 1, wherein the fluid flow rate defined by the groove is controllable to less than 100 litres per hour.

22. A fluid control system according to claim 1, wherein an elongate valve spool core comprises a spool shaft adapted to fit in a snug-fit manner within the passage and an internal shaft extending through the valve housing on only the inlet side or both the inlet and outlet side.

23. A fluid control system according to claim 1, wherein the length of the groove is at least as long as the passage.

24. A method for operating the fluid control system according to claim 1, the method comprising
moving the elongate valve spool core to control the flow of fluid by changing the orifice area.
